(19) United States
(12) Patent Application Publication
(10) Pub. No.: US 2025/0264141 A1
(43) Pub. Date: Aug. 21, 2025

(54) SPRING MEMBER

(71) Applicant: NHK SPRING Co., Ltd., Yokohama-shi, Kanagawa (JP)

(72) Inventors: Norihiro TAJIMA, Yokohama-shi (JP); Atsushi YONEOKA, Yokohama-shi (JP); Shuji TAKAHASHI, Yokohama-shi (JP)

(21) Appl. No.: 18/857,506

(22) PCT Filed: Apr. 24, 2023
(86) PCT No.: PCT/JP2023/016146

§ 371 Date: Oct. 17, 2024

(30) Foreign Application Priority Data
Apr. 26, 2022 (JP) 2022-072074

(51) Int. Cl. F16F 1/26; F28F 13/00

(52) U.S. Cl. CPC F16F 1/26; F16F 2224/0208; F16F 2230/0023; F28F 2013/006

(57) ABSTRACT

A spring member presses a first pressed body and a second pressed body having a heat-generating body in directions away from each other in the first direction, and includes a first member and a second member, in which the first member is formed of a material having a higher thermal conductivity than a material forming the second member, the first member includes first abutting portions and a second abutting portion, both end portions of the second member press one pressed body of the first pressed body and the second pressed body via the first abutting portions, and an intermediate portion of the second member presses the other pressed body via the second abutting portion, and a protective protrusion to which heat from the heat-generating body is transferred is provided to the first member, the protective protrusion being formed integrally with the first member.

### CROSS REFERENCE TO RELATED APPLICATIONS

This is the U.S. national stage of application No. PCT/JP2023/016146, filed on Apr. 24, 2023. Priority under 35 U.S.C. § 119(a) and 35 U.S.C. § 365(b) is claimed from Japanese Application No. 2022-072074, filed Apr. 26, 2022, the disclosure of which is also incorporated herein by reference

### TECHNICAL FIELD

The present invention relates to a spring member.

### BACKGROUND ART

In the related art, as shown in Patent Document 1, for example, a spring member is known which is provided between a first pressed body and a second pressed body, which face each other in a first direction, in a state of pressing the first pressed body and the second pressed body in directions away from each other in the first direction.

### CITATION LIST

### Patent Document

Patent Document 1: Japanese Unexamined Patent Application, First Publication No. 2014-11936

### SUMMARY OF INVENTION

### Problem to be Solved by the Invention

In the spring member of the related art, in a case of attempting to use the spring member to transfer heat from one of the first pressed body and the second pressed body to the other, there is a probability that it is difficult to stably exhibit thermal conduction characteristics of the spring member as designed while prioritizing load characteristics of the spring member.

In a case where one of the first pressed body and the second pressed body is set as a heat-dissipating body and the other includes a heat-generating body, when a heat generation amount of the heat-generating body exceeds a heat dissipation amount of the heat-dissipating body, there is a probability that the heat-generating body may be damaged due to a temperature rise.

The present invention has been made in consideration of such circumstances, and an object of the present invention is to provide a spring member capable of stably exhibiting thermal conduction characteristics as designed and suppressing damage to a heat-generating body.

### Means to Solve the Problem

According to an aspect of the present invention, there is provided a spring member that presses a first pressed body and a second pressed body, which face each other in a first direction, in directions away from each other in the first direction, the second pressed body having a heat-generating body, the spring member including a first member and a second member, in which the first member is formed of a material having a higher thermal conductivity than a material forming the second member, the first member includes first abutting portions which are formed at both end portions thereof in a second direction orthogonal to the first direction and abut on one pressed body of the first pressed body and the second pressed body, and a second abutting portion which is formed at an intermediate portion thereof in the second direction and abuts on the other pressed body of the first pressed body and the second pressed body, both end portions of the second member in the second direction press the one pressed body via the first abutting portions, and an intermediate portion of the second member in the second direction presses the other pressed body via the second abutting portion, and a protective protrusion to which heat from the heat-generating body is transferred is provided to the first member, the protective protrusion being formed integrally with the first member.

According to the above aspect, the spring member includes the first member and the second member. By providing the spring member between the first pressed body and the second pressed body and elastically deforming the second member in the first direction together with the first member, it is possible to strongly bring the first abutting portions of the first member into contact with one pressed body of the first pressed body and the second pressed body and to strongly bring the second abutting portion of the first member into contact with the other pressed body of the first pressed body and the second pressed body, so that thermal conduction characteristics mainly of the first member can be stably exhibited as designed.

The intermediate portion of the second member in the second direction presses the other pressed body via the second abutting portion of the first member. Therefore, it is possible to reliably and strongly bring the second abutting portion into contact with the other pressed body, so that a contact state of the first member with respect to the first pressed body and the second pressed body can be reliably stabilized.

Since the spring member is provided with the first member and a surface of the second member is not plated with the same material as the first member, a heat capacity and a heat dissipation amount can be easily secured at a high level, peeling of the plating does not occur, and the thermal conduction characteristics as designed can be exhibited for a long period of time.

The protective protrusion to which the heat from the heat-generating body is transferred is provided to the first member, and the protective protrusion is formed integrally with the first member. Therefore, for example, even in a case where a heat generation amount of the heat-generating body exceeds a heat dissipation amount of the first pressed body, as the heat from the heat-generating body is transferred to the protective protrusion of the first member, the heat capacity of the first member increases, so that a temperature rise of the heat-generating body is slowed down, and the heat dissipation amount of the first member increases, so that the temperature rise of the heat-generating body is suppressed. Therefore, it is possible to suppress damage to the heat-generating body due to the temperature rise.

The first member and the second member may each be curved or bent such that the intermediate portions thereof in the second direction protrude toward the other pressed body.

The first pressed body may be a heat-dissipating body that dissipates the heat from the heat-generating body to an outside.

The protective protrusion may have a plate body that protrudes from the second abutting portion of the first member in a third direction orthogonal to the first direction and the second direction.

Since the protective protrusion has a plate body protruding from the second abutting portion of the first member in the third direction, when forming the first member and the protective protrusion integrally, it is possible to adopt, for example, press forming, thereby reducing manufacturing constraint. Therefore, the spring member can be easily obtained, and the protective protrusion can be suppressed from restricting smooth deformation of the first member and the second member.

A dense portion bent in a wave shape, or a spiral shape may be formed in the protective protrusion.

Since the dense portion is formed in the protective protrusion, the heat capacity of the first member can be secured while a protrusion length of the protective protrusion from the first member is suppressed.

The dense portion may extend toward the one pressed body in the first direction with respect to a connection portion of the protective protrusion connected to the second abutting portion and may be separated from the one pressed body in a direction intersecting the first direction.

In the protective protrusion, the dense portion, which extends toward the one pressed body in the first direction with respect to the connection portion connected to the second abutting portion, is separated from the one pressed body in a direction intersecting the first direction. Therefore, the dense portion can be prevented from interfering with the one pressed body when the first pressed body and the second pressed body are moved closer to each other in the first direction.

The protective protrusion may include a planar portion, and a heat-dissipating protrusion that protrude from at least one surface of front and back surfaces of the planar portion may be formed in the protective protrusion.

Since the heat-dissipating protrusion is formed in the protective protrusion, a surface area of the protective protrusion can be increased, and a heat dissipation amount of the protective protrusion can be increased. Therefore, the temperature rise of the heat-generating body can be more effectively suppressed, and damage to the heat-generating body can be reliably suppressed.

### Effects of the Invention

According to the invention, the thermal conduction characteristics can be stably exhibited as designed and damage to the heat-generating body can be suppressed.

### BRIEF DESCRIPTION OF DRAWINGS

FIG. 1 is a plan view of a spring member of a first embodiment as viewed from the other side in a first direction.

FIG. 2 is a cross-sectional view taken along the line II-II of FIG. 1.

FIG. 3 is a cross-sectional view of a spring member of a second embodiment.

FIG. 4 is a cross-sectional view of a spring member of a third embodiment.

FIG. 5A is a plan view of a spring member of a fourth embodiment.

FIG. 5B is a cross-sectional view taken along the line A-A of FIG. 5A.

### DESCRIPTION OF EMBODIMENTS

Hereinafter, a first embodiment of a spring member according to the present invention will be described with reference to the accompanying drawings.

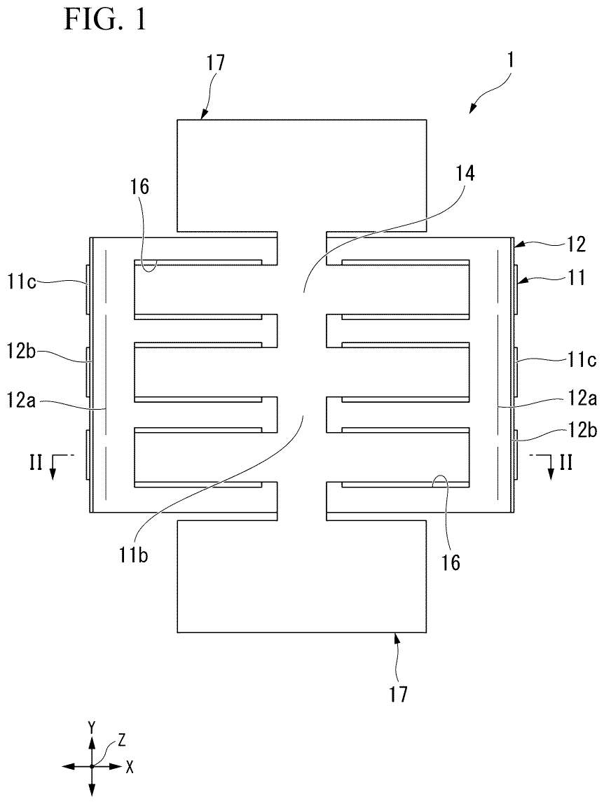

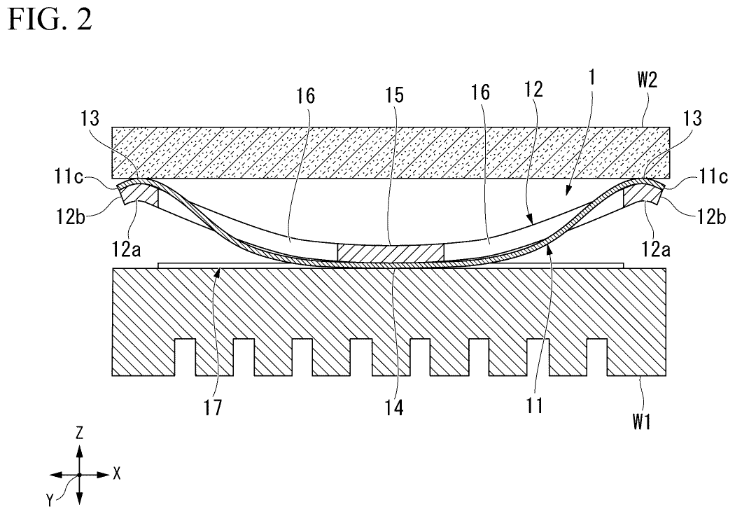

As shown in FIG. 1 and FIG. 2, a spring member 1 of the present embodiment is provided between a first pressed body W1 (the other pressed body or a heat-dissipating body) and a second pressed body W2 (one pressed body) having a heat-generating body, which face each other in a first direction Z, in a state of pressing the first pressed body W1 and the second pressed body W2 in directions away from each other in the first direction Z.

The first pressed body W1 is a heat-dissipating body that dissipates heat from the heat-generating body to an outside. Examples of the first pressed body W1 include a heat sink. Examples of the second pressed body W2 include a semiconductor device. The spring member 1, the first pressed body W1, and the second pressed body W2 constitute a part of a power conversion device.

The spring member 1 includes a conductive plate 11 (first member) and a support plate 12 (second member). The conductive plate 11 and the support plate 12 are provided in a state of not being bonded to each other over the entire region.

The conductive plate 11 and the support plate 12 are each curved or bent such that intermediate portions thereof in a second direction X orthogonal to the first direction Z protrude toward the first pressed body W1. The conductive plate 11 and the support plate 12 may each be curved or bent such that the intermediate portions thereof in the second direction X protrude toward the second pressed body W2.

Hereinafter, a side of the second pressed body W2 along the first direction Z is referred to as one side, and a side of the first pressed body W1 along the first direction Z is referred to as the other side.

Along the second direction X, a side away from a center portion toward an end portion is referred to as an outer side, and a side away from the end portion toward the center portion is referred to as an inner side.

A direction orthogonal to the first direction Z and the second direction X is referred to as a third direction Y.

In the shown example, the conductive plate 11 and the support plate 12 each extend toward one side in a direction from the center portion to the outer side along the second direction X. The conductive plate 11 and the support plate 12 may each be bent, for example, to be pointed toward the other side.

The conductive plate 11 is formed of a material having a higher thermal conductivity than a material forming the support plate 12. The conductive plate 11 is formed of, for example, copper or aluminum. A plate thickness of the conductive plate 11 is, for example, about 50 μm to 100 μm.

The support plate 12 is formed of a material having a higher Young's modulus than the material forming the conductive plate 11. The support plate 12 is formed of, for example, carbon steel or stainless steel.

In the conductive plate 11, first abutting portions 13 that abut on the second pressed body W2 are formed at both end portions in the second direction X, and a second abutting portion 14 that abuts on the first pressed body W1 is formed at the intermediate portion in the second direction X.

The first abutting portions 13 may abut on the first pressed body W1, and the second abutting portion 14 may abut on the second pressed body W2.

The first abutting portion 13 extends in the second direction X such that an open end edge 11c of the conductive plate 11 in the second direction X faces outward in the second direction X. The first abutting portion 13 is curved to have a protruding curved surface toward one side. The first abutting portion 13 is curved around an axis extending in the third direction Y.

The second abutting portion 14 is formed in a flat plate shape with front and back surfaces facing the first direction Z.

The conductive plate 11 has a symmetrical shape with respect to a straight line that passes through a center portion of the conductive plate 11 in the second direction X and extends in the third direction Y as viewed in the first direction Z. The conductive plate 11 has a symmetrical shape with respect to a straight line that passes through a center portion of the conductive plate 11 in the third direction Y and extends in the second direction X as viewed in the first direction Z. The conductive plate 11 has a rectangular shape having a long side in the second direction X as viewed in the first direction Z.

Both end portions of the conductive plate 11 in the second direction X are respectively locked to both end portions of the support plate 12 in the second direction X, and a third abutting portion 15 that abuts on the second abutting portion 14 and sandwiches the second abutting portion 14 between the third abutting portion 15 and the first pressed body W1 in the first direction Z is formed at the intermediate portion of the support plate 12 in the second direction X.

The third abutting portion 15 may sandwich the second abutting portion 14 between the third abutting portion 15 and the second pressed body W2 in the first direction Z.

The third abutting portion 15 is located at a center portion of the support plate 12 in the second direction X, and is formed in a flat plate shape with front and back surfaces facing the first direction Z. A surface of the third abutting portion 15 facing the other side is covered with the second abutting portion 14 of the conductive plate 11. The third abutting portion 15 and the second abutting portion 14 abut on each other in a state in which the third abutting portion 15 and the second abutting portion 14 are not bonded to each other.

The third abutting portion 15 and the second abutting portion 14 may be bonded to each other. In a state before the spring member 1 is provided between the first pressed body W1 and the second pressed body W2, the third abutting portion 15 and the second abutting portion 14 may be separated from each other in the first direction Z.

Both end portions of the conductive plate 11 in the second direction X are movably locked to both end portions of the support plate 12 in the second direction X, respectively. In the shown example, through-holes 16 are formed at least at both end portions of one of the conductive plate 11 and the support plate 12 in the second direction X, and both end portions of the other in the second direction X are movably inserted into the through-holes 16. The through-holes 16 are respectively formed at both portions of the one of the conductive plate 11 and the support plate 12 with the center portion interposed therebetween along the second direction X.

In the shown example, the through-holes 16 are formed in the support plate 12. The first abutting portion 13 of the conductive plate 11 is inserted through the through-hole 16 from the other side to one side in a direction from the inner side to the outer side in the second direction X.

One through-hole 16 is formed in the support plate 12 over the entire region of a portion located between an outer end edge portion 12a, which is connected to an open end edge 12b in the second direction X, and the center portion in the second direction X. The through-holes 16 may be, for example, slits that are formed only at both end portions of the support plate 12 in the second direction X and extend in the third direction Y.

The outer end edge portion 12a of the support plate 12, which is located outside the through-hole 16 in the second direction X and is connected to the open end edge 12b in the second direction X, extends in the second direction X such that the open end edge 12b of the support plate 12 in the second direction X faces outward in the second direction X. The outer end edge portion 12a of the support plate 12 is curved to have a protruding curved surface toward one side. The outer end edge portion 12a of the support plate 12 is curved around an axis extending in the third direction Y. A surface of the outer end edge portion 12a of the support plate 12 facing one side is covered with the first abutting portion 13 of the conductive plate 11. The outer end edge portion 12a of the support plate 12 and the first abutting portion 13 abut on each other in a state in which the outer end edge portion 12a and the first abutting portion 13 are not bonded to each other. The outer end edge portion 12a of the support plate 12 and the first abutting portion 13 may be bonded to each other.

The support plate 12 has a symmetrical shape with respect to a straight line that passes through the center portion of the support plate 12 in the second direction X and extends in the third direction Y as viewed in the first direction Z. The support plate 12 has a symmetrical shape with respect to a straight line that passes through a center portion of the support plate 12 in the third direction Y and extends in the second direction X as viewed in the first direction Z.

The center portions of the support plate 12 and the conductive plate 11 in the second direction X coincide with each other. The center portions of the support plate 12 and the conductive plate 11 in the third direction Y coincide with each other.

In the shown example, the conductive plate 11 is elastically deformed, and the first abutting portions 13 and the second abutting portion 14 are in pressure contact with the support plate 12 in the first direction Z. In a state before the conductive plate 11 and the support plate 12 are assembled to each other, a size of the support plate 12 in the first direction Z is larger than a size of the conductive plate 11 in the first direction Z.

Portions of the conductive plate 11 and the support plate 12 facing each other in the first direction Z, except for the through-hole 16, may abut on each other over the entire region.

A plurality of the conductive plates 11 and a plurality of the support plates 12 are provided to be arranged in the third direction Y. The number of the conductive plates 11 and the number of the support plates 12 are not limited to three in the shown example and may be changed as appropriate.

The conductive plates 11 adjacent to each other in the third direction Y are connected to each other only at the center portions in the second direction X via a connecting piece 11b.

A spring member may be adopted in which, for a configuration in which the plurality of conductive plates 11 are integrally formed as described above, the plurality of support plates 12 divided from each other are respectively attached to the plurality of conductive plates 11. A plurality of the connecting pieces 11b may be provided at intervals in the second direction X, and the connecting piece 11b may be provided at a distance in the second direction X from the center portion of the conductive plate 11 in the second direction X.

The support plates 12 adjacent to each other in the third direction Y are connected to each other over the entire length in the second direction X.

The support plates 12 adjacent to each other in the third direction Y may be connected to each other only at a part or at a plurality of locations in the second direction X.

A spring member may be adopted in which, for a configuration in which the plurality of support plates 12 are integrally formed as described above, the plurality of conductive plates 11 divided from each other are respectively attached to the plurality of support plates 12.

In addition, in the present embodiment, a protective protrusion 17 to which heat from the heat-generating body is transferred is provided to the conductive plate 11, and the protective protrusion 17 is formed integrally with the conductive plate 11. Materials of the protective protrusion 17 and the conductive plate 11 are the same as each other. The protective protrusions 17 are provided on two conductive plates 11 located at both end portions in the third direction Y, among the plurality of conductive plates 11 provided to be arranged in the third direction Y.

The protective protrusion 17 has a plate body protruding from the second abutting portion 14 of the conductive plate 11 in the third direction Y. The heat from the heat-generating body is transferred to the protective protrusion 17 via the conductive plate 11. The protective protrusion 17 is a plate body having a rectangular shape having a long side in the second direction X as viewed in the first direction Z. In the protective protrusion 17, at least a connection portion that is connected to the second abutting portion 14 is formed in a flat plate shape with front and back surfaces facing the first direction Z. The connection portion is located at a center portion of the protective protrusion 17 in the second direction X. The connection portion may be separated in the second direction X from the center portion of the protective protrusion 17 in the second direction X. Both end portions of the protective protrusion 17 in the second direction X are located outside the second abutting portion 14 in the second direction X.

The protective protrusion 17 is formed in a flat plate shape over the entire region. The protective protrusion 17 abuts on the first pressed body W1 over the entire region in the second direction X. Plate thicknesses of the protective protrusion 17 and the conductive plate 11 are the same as each other. The front and back surfaces of the protective protrusion 17 are connected to the front and back surfaces of the second abutting portion 14 without a step.

The protective protrusion 17 has a symmetrical shape with respect to a straight line that passes through a center portion of the protective protrusion 17 in the second direction X and extends in the third direction Y as viewed in the first direction Z. The protective protrusion 17 has a symmetrical shape with respect to a straight line that passes through a center portion of the protective protrusion 17 in the third direction Y and extends in the second direction X as viewed in the first direction Z. The center portions of the protective protrusion 17 and the conductive plate 11 in the second direction X coincide with each other. The center portions of the protective protrusion 17 and the conductive plate 11 in the second direction X may be separated in the second direction X.

As described above, the spring member 1 according to the present embodiment includes the conductive plate 11 and the support plate 12. By providing the spring member 1 between the first pressed body W1 and the second pressed body W2 and elastically deforming the support plate 12 in the first direction Z together with the conductive plate 11, it is possible to strongly bring the first abutting portion 13 of the conductive plate 11 into contact with the second pressed body W2 and to strongly bring the second abutting portion 14 into contact with the first pressed body W1, so that thermal conduction characteristics mainly of the conductive plate 11 can be stably exhibited as designed.

The third abutting portion 15 that abuts on the second abutting portion 14 of the conductive plate 11 and sandwiches the second abutting portion 14 between the third abutting portion 15 and the first pressed body W1 in the first direction Z is formed in the support plate 12. The third abutting portion 15 presses the first pressed body W1 via the second abutting portion 14. Therefore, it is possible to reliably and strongly bring the second abutting portion 14 into contact with the first pressed body W1, so that a contact state of the conductive plate 11 with respect to the first pressed body W1 and the second pressed body W2 can be reliably stabilized.

Since the spring member 1 is provided with the conductive plate 11 and a surface of the support plate 12 is not plated with the same material as the conductive plate 11, a heat capacity and a heat dissipation amount can be easily secured at a high level, peeling of the plating does not occur, and the thermal conduction characteristics as designed can be exhibited for a long period of time.

The protective protrusion 17 to which the heat from the heat-generating body is transferred is provided to the conductive plate 11, and the protective protrusion 17 is formed integrally with the conductive plate 11. Therefore, even in a case where a heat generation amount of the heat-generating body exceeds a heat dissipation amount of the first pressed body W1, the heat from the heat-generating body is transferred to the protective protrusion 17 of the conductive plate 11, the heat capacity of the conductive plate 11 increases, so that a temperature rise of the heat-generating body is slowed down, and the heat dissipation amount of the conductive plate 11 increases, so that the temperature rise of the heat-generating body is suppressed. Therefore, it is possible to suppress damage to the heat-generating body due to the temperature rise.

Since the protective protrusion 17 has a plate body protruding from the second abutting portion 14 of the conductive plate 11 in the third direction Y, when forming the conductive plate 11 and the protective protrusion 17 integrally, it is possible to adopt, for example, press forming, thereby reducing manufacturing constraints. Accordingly, the spring member 1 can be easily obtained, and, the protective protrusion 17 can be suppressed from restricting smooth deformation of the conductive plate 11 and the support plate 12.

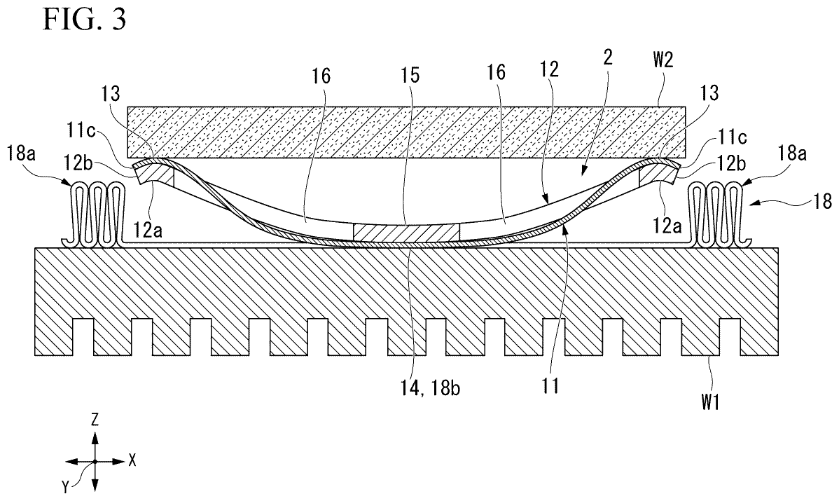

Next, a spring member 2 according to a second embodiment of the present invention will be described with reference to FIG. 3.

In the second embodiment, the same portions as the constituent elements in the first embodiment will be denoted by the same reference signs, descriptions thereof will be omitted, and only different points will be described.

In the spring member 2 according to the present embodiment, dense portions 18a bent in a wave shape are formed in a protective protrusion 18. The dense portions 18a are formed at both end portions of the protective protrusion 18 in the second direction X. The dense portion 18a extends in the second direction X while being bent in the first direction Z. The dense portion 18a is separated from the second pressed body W2 in a direction intersecting the first direction Z and does not face the second pressed body W2 in the first direction Z. In the shown example, the dense portion 18a is separated from the second pressed body W2 in the second direction X.

The dense portion 18a may extend in the first direction Z while being bent in the second direction X, may extend in the third direction Y while being bent in the second direction X, or may extend in the first direction Z while being bent in the third direction Y.

In the protective protrusion 18, a connection portion 18b connected to the second abutting portion 14 is formed in a flat plate shape with front and back surfaces facing the first direction Z. The front and back surfaces of the connection portion 18b of the protective protrusion 18 are connected to the front and back surfaces of the second abutting portion 14 without a step. The connection portion 18b is located at a center portion of the protective protrusion 18 in the second direction X. The connection portion 18b may be separated in the second direction X from the center portion of the protective protrusion 18 in the second direction X. The entire region of the protective protrusion 18, except for the dense portion 18a, is formed in a flat plate shape with the front and back surfaces facing the first direction Z.

The dense portion 18a extends toward the second pressed body W2 in the first direction Z with respect to the connection portion 18b. The protective protrusion 18 abuts on the first pressed body W1 over the entire region in the second direction X. Plate thicknesses of the protective protrusion 18 and the conductive plate 11 are the same as each other.

In each of the dense portions 18a formed at both end portions of the protective protrusion 18 in the second direction X, at least parts of portions adjacent to each other in the second direction X abut on each other in the second direction X. In each of the dense portions 18a, all the portions adjacent to each other in the second direction X may be separated from each other in the second direction X.

As described above, with the spring member 2 according to the present embodiment, since the dense portion 18a is formed in the protective protrusion 18, the heat capacity of the conductive plate 11 can be secured while a protrusion length of the protective protrusion 18 from the conductive plate 11 is suppressed.

In the protective protrusion 18, since the dense portion 18a, which extends toward the second pressed body W2 in the first direction Z with respect to the connection portion 18b connected to the second abutting portion 14, is separated from the second pressed body W2 in a direction intersecting the first direction Z, the dense portion 18a can be prevented from interfering with the second pressed body W2 when the first pressed body W1 and the second pressed body W2 are moved closer to each other in the first direction Z.

In each of the dense portions 18a formed at both end portions of the protective protrusion 18 in the second direction X, since at least parts of portions adjacent to each other in the second direction X abut on each other in the second direction X, the heat from the heat-generating body can be easily and quickly transferred to the entire protective protrusion 18, thereby reliably suppressing damage to the heat-generating body.

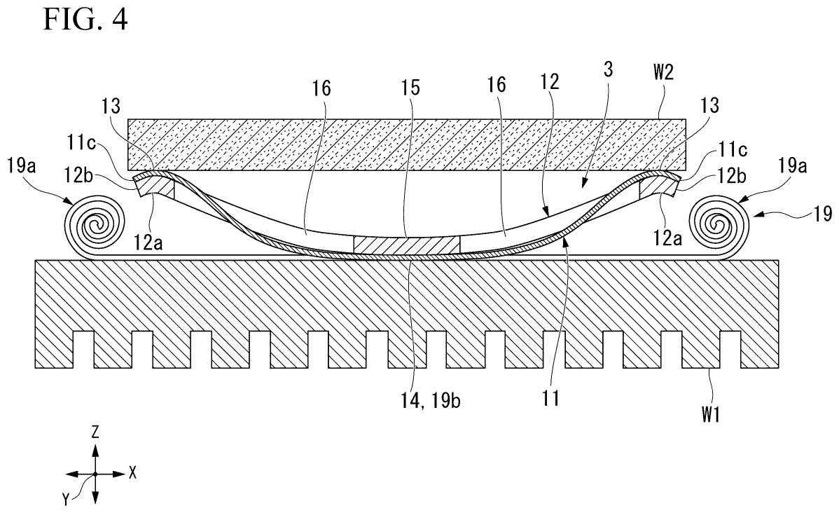

Next, a spring member 3 according to a third embodiment of the present invention will be described with reference to FIG. 4.

In the third embodiment, the same portions as the constituent elements in the first embodiment will be denoted by the same reference signs, descriptions thereof will be omitted, and only different points will be described.

In the spring member 3 of the present embodiment, dense portions 19a bent in a spiral shape are formed in a protective protrusion 19. The dense portions 19a are formed at both end portions of the protective protrusion 19 in the second direction X. The dense portion 19a extends for a plurality of turns around a vortex axis extending in the third direction Y. The dense portion 19a is separated from the second pressed body W2 in a direction intersecting the first direction Z and does not face the second pressed body W2 in the first direction Z. In the shown example, the dense portion 19a is separated from the second pressed body W2 in the second direction X.

The vortex axis may extend, for example, in the first direction Z or may extend in the second direction X.

In the protective protrusion 19, a connection portion 19b connected to the second abutting portion 14 is formed in a flat plate shape with front and back surfaces facing the first direction Z. The front and back surfaces of the connection portion 19b of the protective protrusion 19 are connected to the front and back surfaces of the second abutting portion 14 without a step. The connection portion 19b is located at a center portion of the protective protrusion 19 in the second direction X. The connection portion 19b may be separated in the second direction X from the center portion of the protective protrusion 19 in the second direction X. The entire region of the protective protrusion 19, except for the dense portion 19a, is formed in a flat plate shape with the front and back surfaces facing the first direction Z.

The dense portion 19a extends toward the second pressed body W2 in the first direction Z with respect to the connection portion 19b. The protective protrusion 19 abuts on the first pressed body W1 over the entire region in the second direction X. Plate thicknesses of the protective protrusion 19 and the conductive plate 11 are the same as each other.

In each of the dense portions 19a formed at both end portions of the protective protrusion 19 in the second direction X, at least parts of portions adjacent to each other in a vortex radial direction intersecting the vortex axis as viewed in the third direction Y abut on each other in the vortex radial direction. In each of the dense portions 19a, all the portions adjacent to each other in the vortex radial direction may be separated from each other in the vortex radial direction.

As described above, with the spring member 3 according to the present embodiment, since the dense portion 19a is formed in the protective protrusion 19, the heat capacity of the conductive plate 11 can be secured while a protrusion length of the protective protrusion 19 from the conductive plate 11 is suppressed.

In the protective protrusion 19, since the dense portion 19a, which extends toward the second pressed body W2 in the first direction Z with respect to the connection portion 19b connected to the second abutting portion 14, is separated from the second pressed body W2 in a direction intersecting the first direction Z, the dense portion 19a can be prevented from interfering with the second pressed body W2 when the first pressed body W1 and the second pressed body W2 are moved closer to each other in the first direction Z.

In each of the dense portions 19a formed at both end portions of the protective protrusion 19 in the second direction X, since at least parts of portions adjacent to each other in the vortex radial direction abut on each other in the vortex radial direction, the heat from the heat-generating body can be easily and quickly transferred to the entire protective protrusion 19, thereby reliably suppressing damage to the heat-generating body.

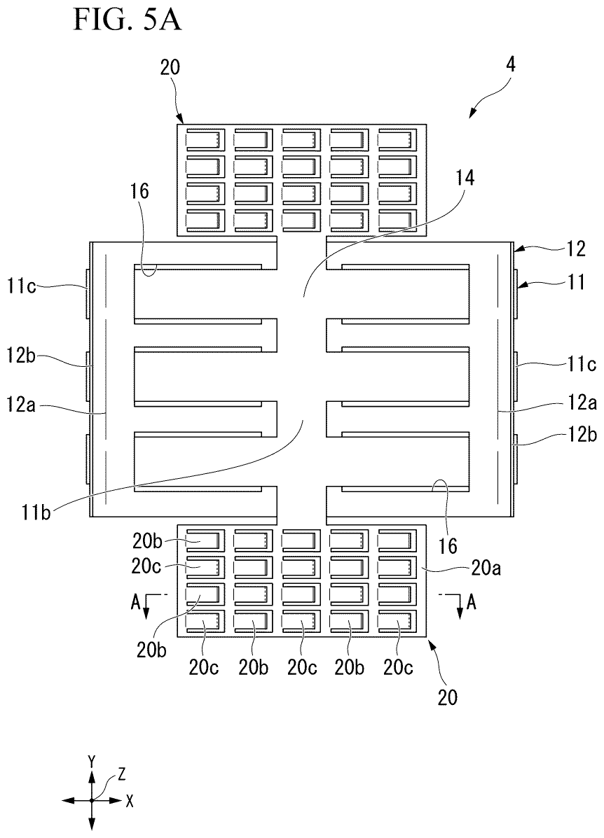

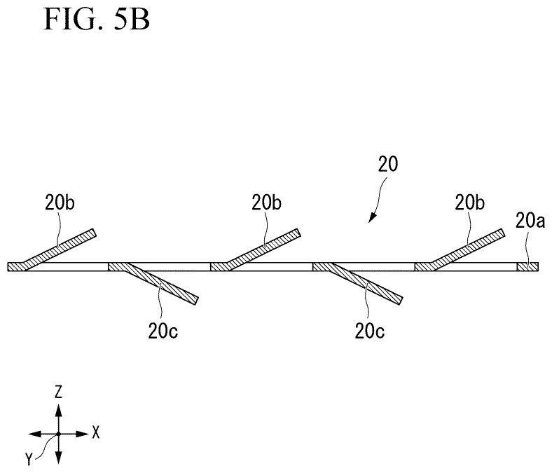

Next, a spring member 4 according to a fourth embodiment of the present invention will be described with reference to FIG. 5A and FIG. 5B.

In the fourth embodiment, the same portions as the constituent elements in the first embodiment will be denoted by the same reference signs, descriptions thereof will be omitted, and only different points will be described.

In the spring member 4 according to the present embodiment, a protective protrusion 20 includes a planar portion 20a of which front and back surfaces face the first direction Z. In the protective protrusion 20, first heat-dissipating protrusions 20b (heat-dissipating protrusion) and second heat-dissipating protrusions 20c (heat-dissipating protrusion) that respectively protrude from front and back surfaces of the planar portion 20a are formed. The first heat-dissipating protrusion 20b protrudes from the planar portion 20a to one side, and the second heat-dissipating protrusion 20c protrudes from the planar portion 20a to the other side. For example, the first heat-dissipating protrusion 20b is formed by forming a U-shaped slit in the planar portion 20a and cutting and raising a portion surrounded by the slit such that the portion protrudes to one side. The second heat-dissipating protrusion 20c is formed by forming a U-shaped slit in the planar portion 20a and cutting and raising a portion surrounded by the slit such that the portion protrudes to the other side. The first heat-dissipating protrusion 20b and the second heat-dissipating protrusion 20c may be formed by bonding members different from the planar portion 20a to the front and back surfaces of the planar portion 20a.

The first heat-dissipating protrusions 20b and the second heat-dissipating protrusions 20c are alternately disposed in the second direction X and are also alternately disposed in the third direction Y. It should be noted that the disposition of the first heat-dissipating protrusions 20b and the second heat-dissipating protrusions 20c is not limited thereto.

In the protective protrusion 20, only the first heat-dissipating protrusions 20b may be formed, or only the second heat-dissipating protrusions 20c may be formed.

As described above, with the spring member 4 according to the present embodiment, the heat-dissipating protrusion 20b, 20c that protrudes from at least one surface of the front and back surfaces of the planar portion 20a is formed in the protective protrusion 20. As a result, a surface area of the protective protrusion 20 can be increased, and a heat dissipation amount of the protective protrusion 20 can be increased. Therefore, the temperature rise of the heat-generating body can be more effectively suppressed, and damage to the heat-generating body can be reliably suppressed.

The technical scope of the present invention is not limited to the above-described embodiments, and various modifications can be made within the scope not departing from the meaning of the present invention.

For example, the protective protrusions 17, 18, 19, and 20 may be provided on the first abutting portion 13 such that heat from the second pressed body W2 may be directly transferred to the protective protrusions 17 to 20 without being transferred through the conductive plate 11.

The protective protrusions 17 to 20 may be provided in a non-contact manner with the first pressed body W1 and the second pressed body W2 over the entire region.

The plate thicknesses of the protective protrusions 17 to 20 and the conductive plate 11 may be different from each other.

A configuration in which the spring members 1, 2, 3, and 4 do not have the through-hole 16 may be adopted. For example, both end portions of the conductive plate 11 in the second direction X may be wrapped around both end portions of the support plate 12 in the second direction X, or both end portions of the support plate 12 and the conductive plate 11 in the second direction X may be fixed to each other by, for example, soldering.

As the spring members 1 to 4, the configuration has been shown in which the plurality of conductive plates 11 and the plurality of support plates 12 are provided to be arranged in the third direction Y. However, a configuration may be adopted in which one conductive plate 11 and one support plate 12 are provided.

In addition, the components in the above-described embodiments can be appropriately replaced with well-known components within a range not departing from the meaning of the present invention, and the embodiments and modified examples described above may be appropriately combined.

### INDUSTRIAL APPLICABILITY

According to the present invention, the thermal conduction characteristics can be stably exhibited as designed and damage to the heat-generating body can be suppressed.

### REFERENCE SIGNS LIST

1, 2, 3, 4: Spring member
11: Conductive plate (first member)
12: Support plate (second member)
13: First abutting portion
14: Second abutting portion
15: Third abutting portion
17, 18, 19, 20: Protective protrusion
18a, 19a: Dense portion
18b, 19b: Connection portion
20a: Planar portion
20b: First heat-dissipating protrusion (heat-dissipating protrusion)
20c: Second heat-dissipating protrusion (heat-dissipating protrusion)
W1: First pressed body (the other pressed body)
W2: Second pressed body (one pressed body)
X: Second direction
Y: Third direction
Z: First direction

What is claimed is:

1. A spring member that presses a first pressed body and a second pressed body, which face each other in a first direction, in directions away from each other in the first direction, the second pressed body having a heat-generating body, the spring member comprising:
a first member; and
a second member,
wherein the first member is formed of a material having a higher thermal conductivity than a material forming the second member,
the first member includes first abutting portions which are formed at both end portions thereof in a second direction orthogonal to the first direction and abut on one pressed body of the first pressed body and the second pressed body, and a second abutting portion which is formed at an intermediate portion thereof in the second direction and abuts on the other pressed body of the first pressed body and the second pressed body,
both end portions of the second member in the second direction press the one pressed body via the first abutting portions, and an intermediate portion of the second member in the second direction presses the other pressed pressing body via the second abutting portion, and
a protective protrusion to which heat from the heat-generating body is transferred is provided to the first member, the protective protrusion being formed integrally with the first member.

2. The spring member according to claim 1,
wherein the first member and the second member are each curved or bent such that the intermediate portions thereof in the second direction protrude toward the other pressed body.

3. The spring member according to claim 1,
wherein the first pressed body is a heat-dissipating body that dissipates the heat from the heat-generating body to an outside.

4. The spring member according to claim 1,
wherein the protective protrusion has a plate body that protrudes from the second abutting portion of the first member in a third direction orthogonal to the first direction and the second direction.

5. The spring member according to claim 4,
wherein a dense portion bent in a wave shape, or a spiral shape is formed in the protective protrusion.

6. The spring member according to claim 5,
wherein the dense portion extends toward the one pressed body in the first direction with respect to a connection portion of the protective protrusion connected to the second abutting portion, and is separated from the one pressed body in a direction intersecting the first direction.

7. The spring member according to claim 4,
wherein the protective protrusion includes a planar portion, and
a heat-dissipating protrusion that protrude from at least one surface of front and back surfaces of the planar portion is formed in the protective protrusion.
